(19) United States
(12) Patent Application Publication
(10) Pub. No.: US 2026/0051679 A1
(43) Pub. Date: Feb. 19, 2026

(54) EASY-LOCK CONNECTOR, CONNECTOR HOUSING AND EASY-LOCK CONNECTOR ASSEMBLY

(71) Applicant: P-TWO INDUSTRIES INC., Taoyuan City (TW)

(72) Inventors: Hsien-Chang Lin, Taoyuan City (TW); Chun-Wei Chang, Taoyuan City (TW); Chih-Wei Huang, Taoyuan City (TW)

(21) Appl. No.: 19/257,009

(22) Filed: Jul. 1, 2025

(30) Foreign Application Priority Data
Aug. 14, 2024 (TW) 113130450

(51) Int. Cl. H01R 12/77; H01R 12/82

(52) U.S. Cl. CPC H01R 12/774; H01R 12/82

(57) ABSTRACT

An easy-lock connector which comprises an insulating housing, a plurality of contacts held by the insulating housing, two locking members and a push bar member is provided. The insulating housing has a receiving space into which a mating connector is fitted in a first direction. The locking members are arranged to lock the mating connector inserted into the easy-lock connector. The push bar member is operated to bias the locking arms of the locking members away from the latched position for unlocking the mating connector. By means of the push bar member, the operability of the easy-lock connector is improved.

### CROSS-REFERENCES TO RELATED APPLICATIONS

This application claims the benefit of priority to Taiwanese Patent Application No. 113130450 filed on Aug. 14, 2024, which is hereby incorporated by reference in its entirety.

### BACKGROUND OF THE INVENTION

### Field of the Invention

The present invention relates to an easy-lock connector, and more particularly to an easy-lock connector capable of releasing the lock on a mating connector by a single-handed operation. The mating connector is composed of a connector housing and a flat connection object such as a flexible flat cable (FFC), a flexible printed circuit (FPC), a card board or the like.

### Descriptions of the Related Art

Taiwanese Utility Model Patent No. M644042U (Patent Document 1) discloses a connector for a flexible flat cable. The connector disclosed in Patent Document 1 has an actuator pivoted on an insulating housing, and the lock on the flexible flat cable (FFC) is released by pressing the body of the actuator and pivotably operating the actuator. However, this actuator has a certain thickness, making it difficult to achieve a low-profile connector.

Taiwan Utility Model Patent No. M591717U (Patent Document 2) discloses a connector for a flexible flat cable. Patent Document 2 describes a connector housing functioning as a plug which is mounted on the insertion end of the flexible flat cable. This configuration allows the mating direction of the flexible flat cable with the easy-lock connector to be changed, facilitating automated insertion of the flexible flat cable into the easy-lock connector. Additionally, it enhances the operability and protection of the flexible flat cable. However, in the easy-lock connector disclosed in Patent Document 2, the flexible flat cable can only be released by simultaneously operating two separate locking members, resulting in poor operability for releasing the flexible flat cable. Since the operated portions of the locking members are positioned on the same side as the flexible flat cable, the release operation may be hindered by the presence of the flexible flat cable.

### SUMMARY OF THE INVENTION

One object of the present invention is to provide an easy-lock connector which has excellent operability and can be operated with one hand for releasing the lock on the mating connector.

Another object of the present invention is to provide an easy-lock connector having a low profile and suitable for a compact or thin electronic machine.

A further object of the present invention is to provide an easy-lock connector, wherein a mating connector can be easily locked by simply inserting the mating connector into the easy-lock connector, thus facilitating automated assembly of the easy-lock connector and the mating connector.

According to the first aspect of the present invention, an easy-lock connector is provided, which comprises:
an insulating housing, having an accommodation space, wherein a mating connector is to be inserted in a first direction into the accommodation space in such a manner that at least a part of the mating connector is received in the accommodation space;
a plurality of contacts held by the insulating housing, the plurality of contacts being arranged in a second direction perpendicular to the first direction, each contact including a contact portion extending into the accommodation space and a connection terminal portion opposite to the contact portion;
two lock members respectively arranged at two sides of the accommodation space in the second direction, each lock member including a fixed portion, a locking arm extending in a third direction perpendicular to the first direction and the second direction and an actuated portion formed on a free end of the locking arm, each lock member being arranged in such a manner that the locking arm is capable of moved between a latched position and an unlatched position and is normally biased to the latched position, the locking arm being formed with a first engaging means for being engaged with a second engaging means formed on the mating connector and preventing the mating connector from being detached from the easy-lock connector when the mating connector is inserted into the accommodation space; and
a push bar including a bar body and two rocker arms respectively formed on two ends of the push bar, the bar body including an operated portion extending in the second direction and two actuating portions respectively formed on two ends of the operated portion and extending in the third direction, the two rocker arms being capable of rotation about an axis parallel to the second direction with respect to the insulating housing,
wherein the two actuating portions of the push bar are brought to interact with the actuated portions of the two lock members by operating the operated portion so that movement of the two actuating portions in the first direction causes the locking arms of the two lock members to be moved away from the latched position in the second direction.

According to the easy-lock connector of the present invention, the easy-lock connector further includes a shell attached to the insulating housing and covering at least a part of the insulating housing, wherein the shell is formed with two stopper tabs respectively positioned above the two rocker arms for preventing the two rocker arms from being swung upwardly.

According to the easy-lock connector of the present invention, the first engaging means formed on the locking arm is in form of a slot.

According to the easy-lock connector of the present invention, the actuated portion includes an inclined guide surface.

According to the easy-lock connector of the present invention, wherein the insulating housing includes a flat rectangular body and a peripheral wall formed along an edge of the flat rectangular body, the accommodation space is defined by the flat rectangular body and the peripheral wall, the peripheral wall is composed of a front wall portion, a rear wall portion opposite to the front wall portion and two lateral wall portions connecting the front wall portion and the rear wall portion, the two lock members are positioned adjacent to the two lateral wall portions respectively, and each lock member is arranged in such a manner that the fixed portion is positioned adjacent to the front wall portion and that the locking arm extends beyond the rear wall portion.

According to the easy-lock connector of the present invention, the push bar is pivoted on the two lateral wall portions of the insulating housing.

According to the easy-lock connector of the present invention, the peripheral wall has an upper inner edge which is chamfered.

According to the easy-lock connector of the present invention, the insulating housing is formed with at least one positioning post for guiding insertion of the mating connector and positioning the mating connector.

According to the second aspect of the present invention, a connector housing is provided, which is attached to an insertion end of a flat connection object, the flat connection object including a plurality of electrode portions formed on the insertion end, wherein a mating connector for the easy-lock connector according to the first aspect of the present invention is composed of the connector housing and the flat connector object, the connector housing comprises two latch portions which are arranged in parallel to a plane perpendicular to the second direction, and each latch portion is formed with the second engaging means for being engaged with the first engaging means.

According to the third aspect of the present invention, a connector assembly is provided, which includes the easy-lock connector according to the first aspect of the present invention and the mating connector matable with the easy-lock connector, the mating connector comprising: a flat connection object including an insertion end and a plurality of electrode portions formed on the insertion end; and a connector housing attached to the insertion end of the flat connection object, the connector housing comprising two latch portions which are arranged in parallel to a plane perpendicular to the second direction, each latch portion being formed with the second engaging means for being engaged with the first engaging means.

According to the easy lock connector of the present invention, the provision of the push bar capable of interacting with the locking members improves the operability of the easy-lock connector while also allowing the easy-lock connector to have a low profile.

The above and other objects and advantages of the present invention will become apparent from the accompanying drawings and the following detailed description.

### BRIEF DESCRIPTION OF THE DRAWINGS

FIG. 1 is a perspective view of an easy-lock connector assembly in a mated state according to the embodiment of the present invention, wherein the easy-lock connector assembly comprises an easy-lock connector and a mating connector.

FIG. 2 is a perspective view of the easy-lock connector assembly in an unmated state according to the embodiment of the present invention.

FIG. 3 is a perspective view of the easy-lock connector according to the embodiment of the present invention.

FIG. 4 is an exploded perspective view of the easy-lock connector according to the embodiment of the present invention.

FIG. 5 is a perspective view of a connector housing.

FIG. 6 is a perspective view of a pair of lock member.

FIG. 7 is a perspective view of a plurality of contacts.

FIG. 8 is a perspective view of a push bar.

FIG. 9 is a perspective view of a shell.

FIG. 10 is a perspective view of the mating connector according to the embodiment of the present invention which is matable with the easy-lock connector.

FIG. 11 is an exploded perspective view of the mating connector according to the embodiment of the present invention.

FIG. 12 is a front view of the mating connector according to the embodiment of the present invention.

FIG. 13 is a perspective view of an upper housing of the mating connector according to the embodiment of the present invention.

FIG. 14 is a perspective view of a flat connection object.

FIG. 15 is a view schematically illustrating the locking members of the easy-lock connector according to the present invention in a latched position, wherein the shell of the easy-lock connector is not shown.

FIG. 16 is a view schematically illustrating the locking members of the easy-lock connector according to the present invention in an unlatched position, wherein the shell of the easy-lock connector is not shown.

FIG. 17 is a view schematically illustrating the removal of the mating connector from the easy-lock connector.

### DETAILED DESCRIPTION OF THE PREFERRED EMBODIMENT

The easy-lock connector assembly according to the embodiments of the present invention will be described with reference to the drawings. In the drawings, the same components or components with similar functions are denoted by the same reference numerals. The drawings are not necessarily drawn to scale.

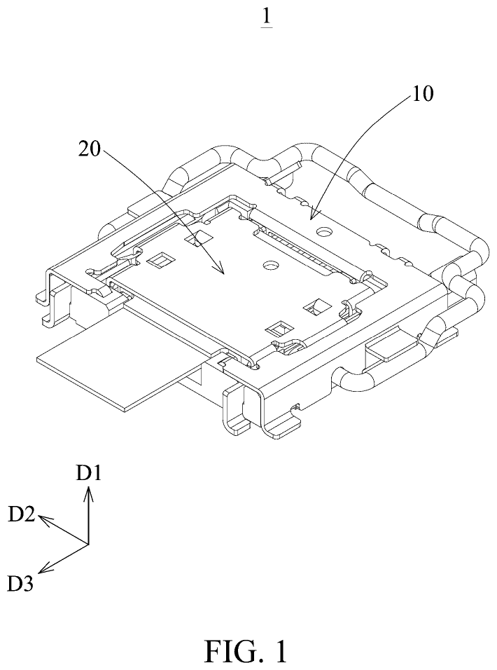

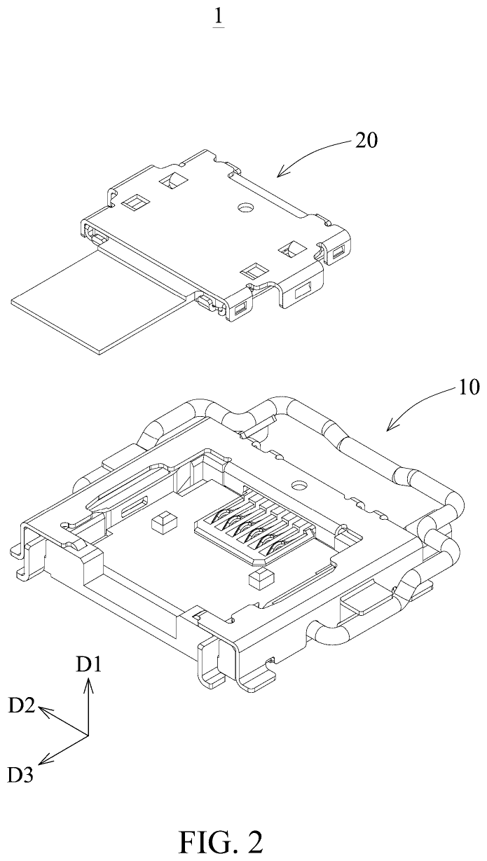

The elements of the easy-lock connector assembly according to the embodiment of the present invention are described by referring to FIGS. 1 and 2. FIG. 1 is a perspective view of the easy-lock connector assembly according to the embodiment of the present invention in a mated state, and FIG. 2 is a perspective view of the easy-lock connector assembly according to the embodiment of the present invention in an unmated state. The easy-lock connector assembly is entirely denoted by the reference numeral 1. The easy-lock connector assembly 1 comprises an easy-lock connector 10 and a mating connector 20 matable with the easy-lock connector 10 in a first direction D1. The easy-lock connector 10 is embodied as a receptacle connector, and the mating connector 20 is embodied as a plug connector.

The mating connector 20 is formed by attaching a connector housing to an insertion end of a flat connection object, such as a flexible flat cable (FFC) or a flexible printed circuit (FPC). In the description, the assembly composed of the connector housing and the flat connection object is referred to as the mating connector.

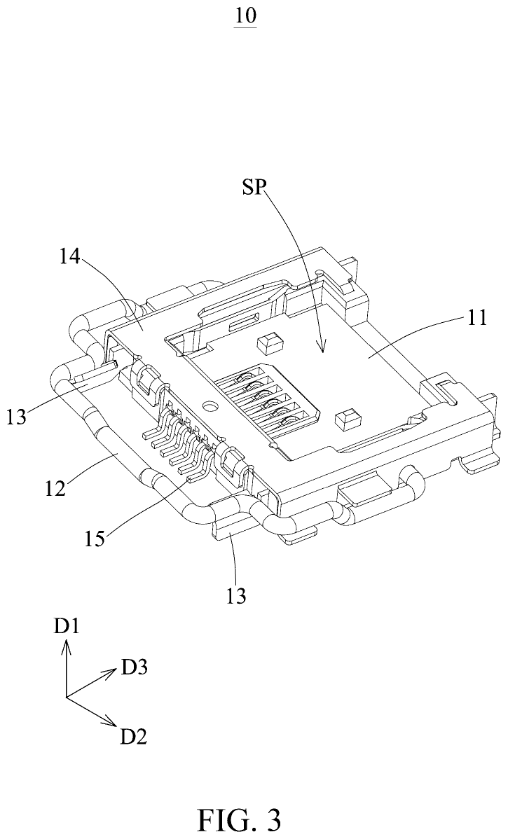

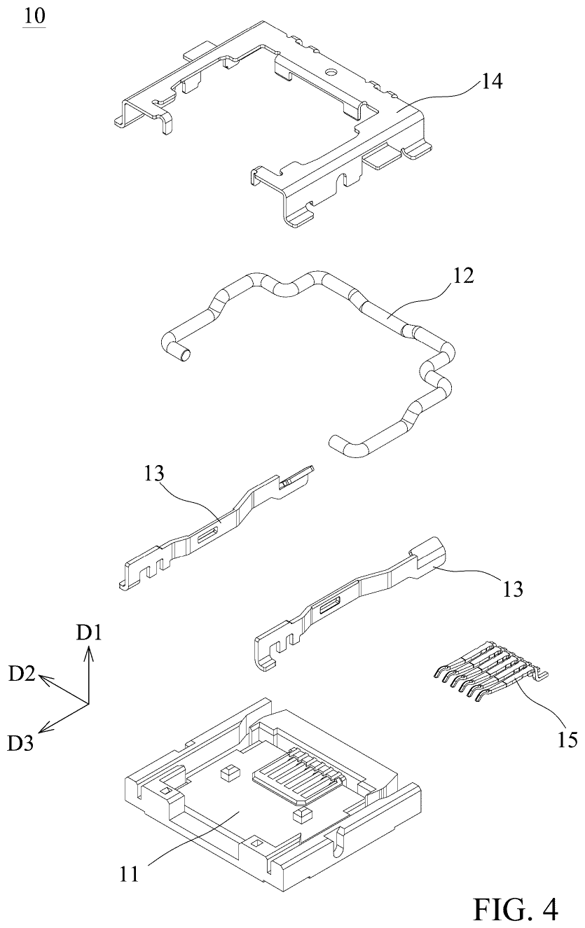

The easy-lock connector 10 according to the embodiment of the present invention is described by referring to FIGS. 3 and 4. FIG. 3 is a perspective view of the easy-lock connector according to the embodiment of the present invention, and FIG. 4 is an exploded perspective view of the easy-lock connector according to the embodiment of the present invention. The easy-lock connector 10 comprises an insulating housing 11, a push bar 12, two locking members 13, a shell 14 and a plurality of contacts 15.

The mating connector 20 is matable with the easy-lock connector 10 in the first direction D1 (i.e., the height direction or mating direction). The flat connection object forming a portion of the mating connector 20 may be a flexible flat cable (FFC) or a flexible printed circuit (FPC), but the present invention is not limited thereto. The flat connection object may also be a card board. The flat connection object includes a plurality of electrode portions formed on its insertion end.

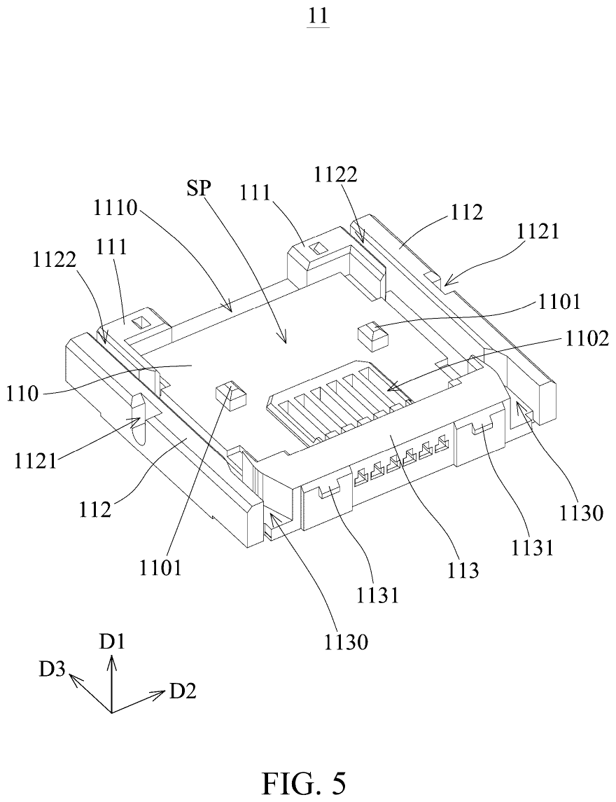

FIG. 5 is a perspective view of the insulating housing 11. The configuration of the insulating housing 11 is described by referring to FIG. 5. The insulating housing 11 is made of an insulating synthetic resin or polymer material. The insulating housing 11 has a flat rectangular body 110 and a peripheral wall formed at the edge of the flat rectangular body 110. The upper inner edge of the peripheral wall is chamfered. The flat rectangular body 110 and the peripheral wall define an accommodation space SP. The peripheral wall consists of a front wall portion 111, a rear wall portion 113 opposite to the front wall portion 111 and two lateral wall portions 112 connecting the front wall portion 111 and the rear wall portion 113.

The flat rectangular body 110 is formed with a plurality of retaining grooves 1102. The retaining grooves 1102 are arranged along a second direction D2 (i.e., the width direction) perpendicular to the first direction and are spaced apart from each other. Each contact 15 is held in a respective retaining groove 1102. The flat rectangular body 110 has two positioning posts 1101 spaced apart in the second direction D2. The top end of each positioning post 1101 is in the shape of a truncated pyramid. The positioning posts 1101 are provided for guiding the insertion of the mating connector 20 and for positioning the mating connector 20.

The front wall portion 111 is formed with a notch 1110. The notch 1110 is provided for preventing interference between the front wall portion 111 and the flat connection object. Each lateral wall portion 112 includes a first limiting recess 1121 for pivotally mounting the push bar 12 and a locking member fixing portion 1122 adjacent to the front wall portion 111. The first limiting recess 1121 is open upward in the first direction D1 to facilitate the placement of the push bar 12.

The end of the rear wall portion 113 is spaced from the lateral wall portion 112 by a flared gap 1130. Specifically, the width of the gap 1130 gradually increases rearward along a third direction D3 (i.e., the front-rear direction) perpendicular to both the first direction D1 and the second direction D2. The gap 1130 allows a portion of the locking member 13 to move in the second direction D2.

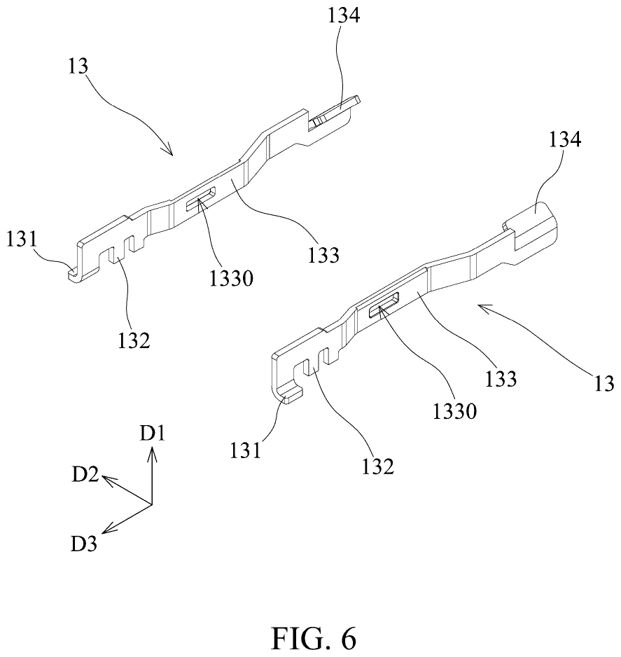

FIG. 6 is a perspective view of a pair of locking members 13. Each locking member 13 is an elongated component formed by stamping and bending a metal plate. Each locking member 13 comprises a soldered portion 131, a fixed portion 132, a locking arm 133 and an actuated portion 134. The soldered portion 131 is formed at one end of the fixed portion 132, while the locking arm 133 extends substantially in the third direction D3 from the other end of the fixed portion 132 opposite to the soldered portion 131. The soldered portion 131 can be soldered to a solder pad formed on a circuit board by using surface mount technology (SMT). The actuated portion 134 is formed at a distant end of the locking arm 133. The locking arm 133 is provided with a first engaging means for being engaged with a second engaging means formed on the connector housing of the mating connector 20, thereby locking the mating connector 20. In this embodiment, the first engaging means is embodied as a slot 1330.

The locking member 13 is arranged at the inner side of the lateral wall portion 112 and adjacent to the lateral wall portion 112. The fixed portion 132 of the locking member 13 is fixed to the locking member fixing portion 1122, such that the fixed portion 132 is positioned adjacent to the front wall portion 111. The locking arm 133 of the locking member 13 extends beyond the rear wall portion 113 substantially in the third direction D3 from the fixed portion 132 and is elastically displaceable between a latched position and an unlatched position. The locking member 13 is arranged so that the locking arm 133 is normally biased to the latched position.

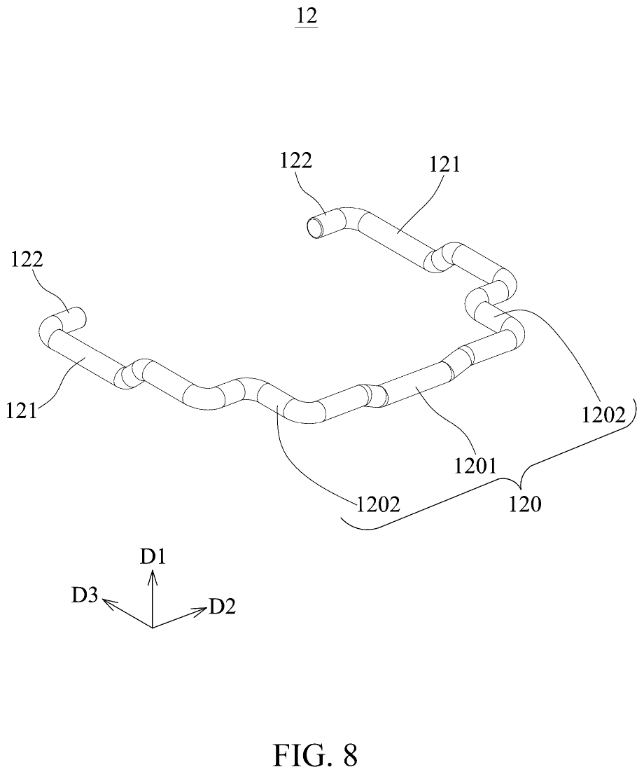

The actuated portion 134 of the locking member 13 has an inclined guide surface. The actuating portion 1202 of the push bar (shown in FIG. 8) is abut against the guide surface and interacts with the guide surface. Interaction between the actuating portion 1202 of the push bar and the actuated portion 134 allows the locking arm 133 to be biased from the latched position to the unlatched position.

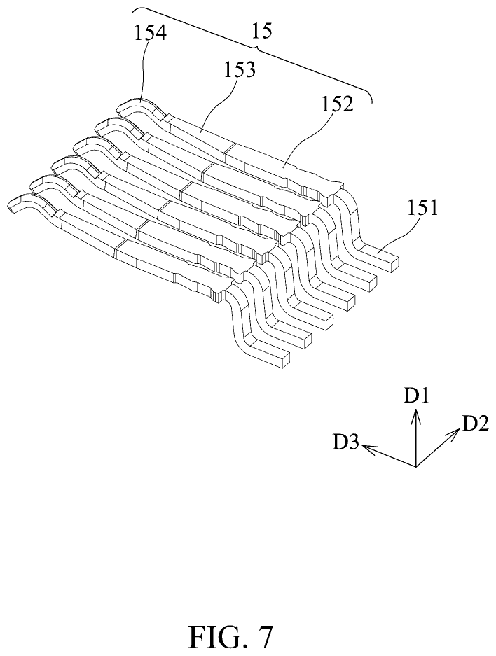

FIG. 7 is a perspective view of the plurality of contacts 15. The contacts 15 are arranged in one row along the second direction D2 and are retained by the insulating housing 11. Each contact 15 is made of copper or a copper alloy. The contact 15 includes a connection terminal portion 151, a held portion 152, a contact arm 153 and a contact portion 154. The contact arm 153 extends from one end of the held portion 152, while the connection terminal portion 151 extends from the other end of the held portion 152. The held portion 152 is formed with a barb structure. The held portion 152 is inserted into a contact holding hole formed in the insulating housing 11 and communicated with the retaining groove 1102 in an interference-fit manner. The contact portion 154 is formed on a distant end of the contact arm 153. The contact arm 153 extends in the third direction D3 into the accommodation space SP so that the contact portion 154 is capable of contacting the electrode portion formed on the flat connection object. The connection terminal portion 151 protrudes from the insulating housing 11 and can be soldered to a solder pad formed on a circuit board by using surface mount technology (SMT).

FIG. 8 is a perspective view of the push bar. As shown in FIG. 8, the push bar 12 includes a bar body 120 and two rocker arms 121 respectively formed on two ends of the bar body 120. The rocker arms 121 are perpendicular to the bar body 120. A pivot portion 122 is formed on a distant end of each rocker arm 121. The pivot portions 122 are received in the first limiting recesses 1121 of the insulating housing 11, allowing the rocker arms 121 to be pivotably mounted on the insulating housing 11 and rotatable about an axis parallel to the second direction D2. In this manner, the push bar 12 is pivotally mounted on the insulating housing 11.

The bar body 120 includes an operated portion 1201 extending along the second direction D2 and two actuating portions 1202 extending in the third direction D3. The operated portion 1201 is formed between the two actuating portions 1202. The bar body 120 is configured such that the height of the operated portion 1201 in the first direction D1 is slightly lower than that of the actuating portions 1202. This design restricts the downward movement of the operated portion 1201 in the first direction D1, preventing the operated portion 1201 from being excessively pressed and suppressing the upward reaction force exerted by the pivot portions 122 on the easy-lock connector in the first direction. If necessary, the operated portion 1201 can be further shaped into a flat profile to increase the contact area with the user's fingers.

According to the embodiment of the present invention, the push bar 12 is formed by bending a metal bar, but the present invention is not limited thereto. The push bar 12 may be formed by stamping a metal plate or by powder metallurgy such as metal injection molding (MIM). Additionally, the push bar member 12 may be made of non-metallic materials such as polymer materials. In order to ensure sufficient strength or rigidity, the push bar 12 is preferably made of metal material.

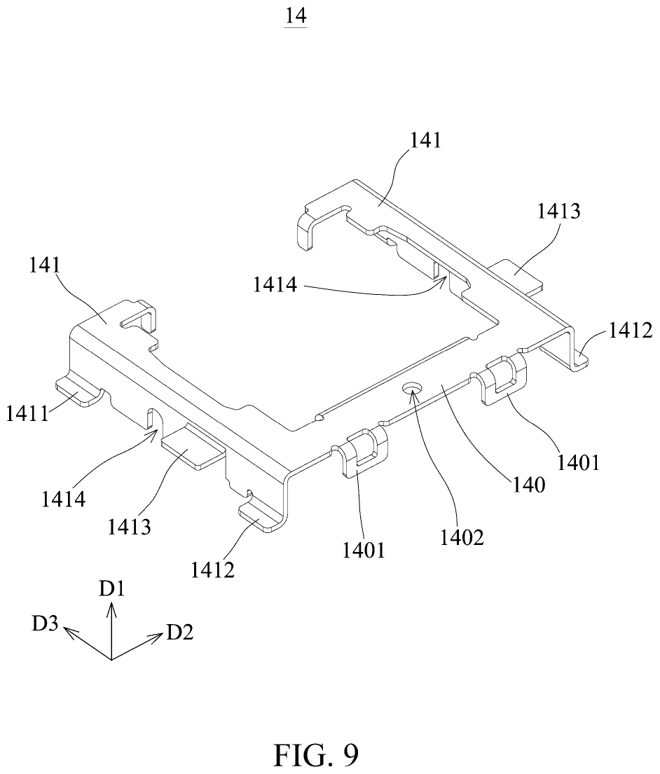

FIG. 9 is a perspective view of the shell 14. The shell 14 is formed by stamping and bending a metal plate. The shell 14 is configured to have a generally U-shaped structure when viewed in the first direction D1. The shell 14 includes two lateral shell portions 141 and a connecting portion 140 connecting the two lateral shell portions 141. The lateral shell portions 141 at least partially cover the lateral wall portions 112, while the connecting portion 140 at least partially covers the rear wall portion 113.

The lower edge of the lateral shell portion 141 includes a first soldered portion 1411 adjacent to the front end of the lateral shell portion 141 and a second soldered portion 1412 adjacent to the rear end of the lateral shell portion 141. The first soldered portion 1411 and the second soldered portion 1412 can be soldered to solder pads on the circuit board by using surface-mount technology (SMT). In this manner, the easy-lock connector 10 can be firmly mounted on the circuit board.

The lateral shell portion 141 is formed with a second limiting recess 1414 corresponding to the first limiting recess 1121. The second limiting recess 1414 is open downward in the first direction D1. When the shell 14 is attached to the insulating housing 11, the first limiting recess 1121 and the second limiting recess 1414 cooperate to pivotally support the pivot portion 122 of the push bar 12. The lateral shell portion 141 is further formed with a stopper tab 1413 positioned above the rocker arm 121 of the push bar 12. The stopper tab 1413 is provided for preventing the rocker arm 121 of the push bar 12 from being pivoted upward.

The rear edge of the connecting portion 140 is formed with an engagement portion 1401, which is provided for engagement with a protrusion 1131 formed on the rear wall portion 113 of the insulating housing 11. By engaging the engagement portion 1401 with the protrusion 1131, the shell 14 is prevented from being detached from the insulating housing 11. The connecting portion 140 is further formed with an alignment hole 1402. When a robotic arm picks up the mating connector 20 and aligns it with the accommodation space SP of the easy-lock connector 10, the alignment hole 1402 serves as an alignment mark which can be recognized by a machine vision system.

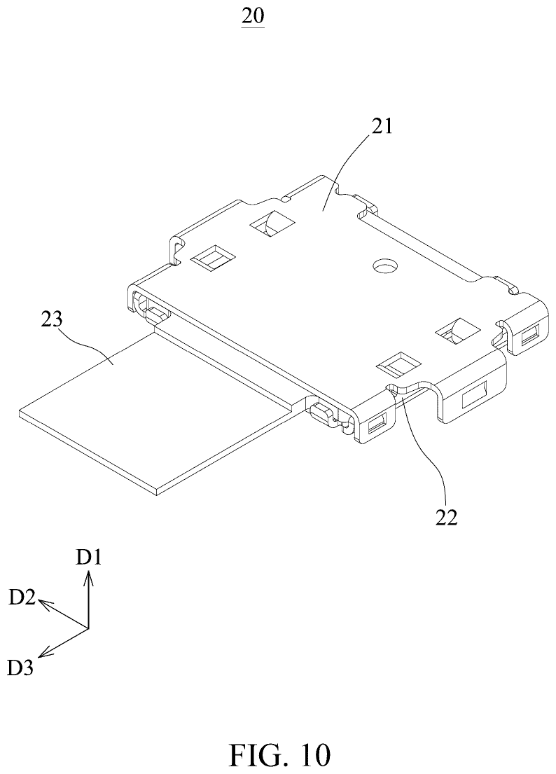

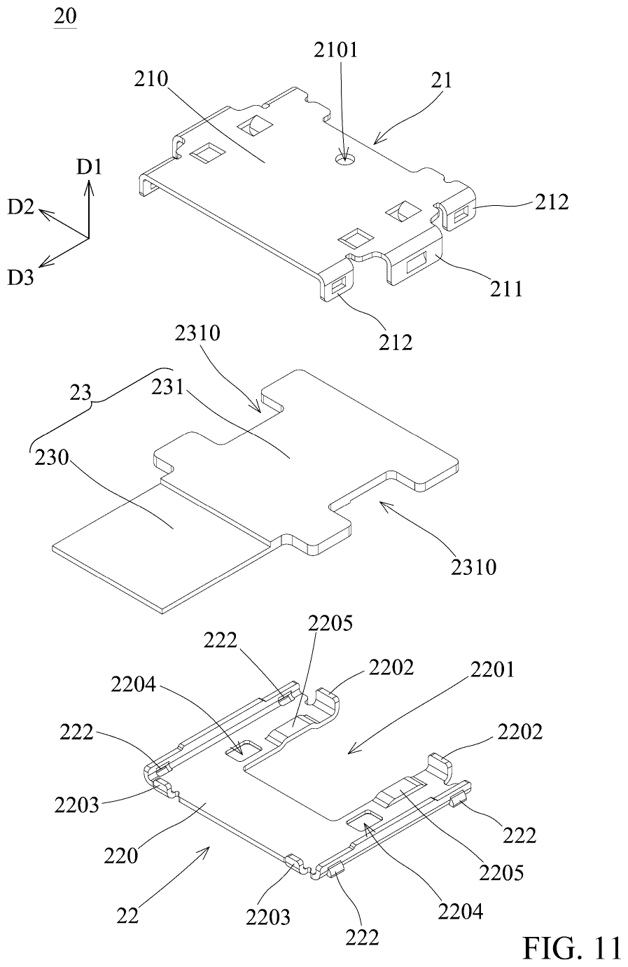

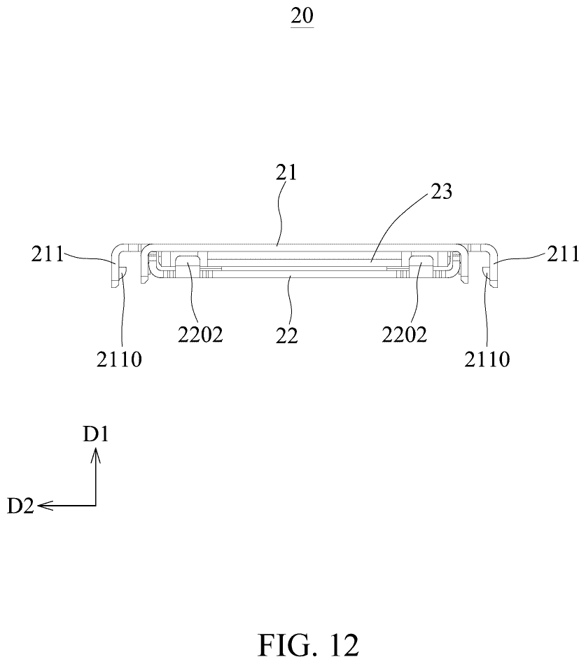

The mating connector of the embodiment of the present invention embodiment is described by referring to FIGS. 10, 11 and 12. FIG. 10 is a perspective view of the mating connector according to the embodiment of the present invention, FIG. 11 is an exploded perspective view of the mating connector according to the embodiment of the present invention, and FIG. 12 is a front view of the mating connector according to the embodiment of the present invention. The mating connector 20 comprises a connector housing composed of an upper housing 21 and a lower housing 22 as well as a flat connecting object 23. The connector housing is mounted on the flat connecting object 23.

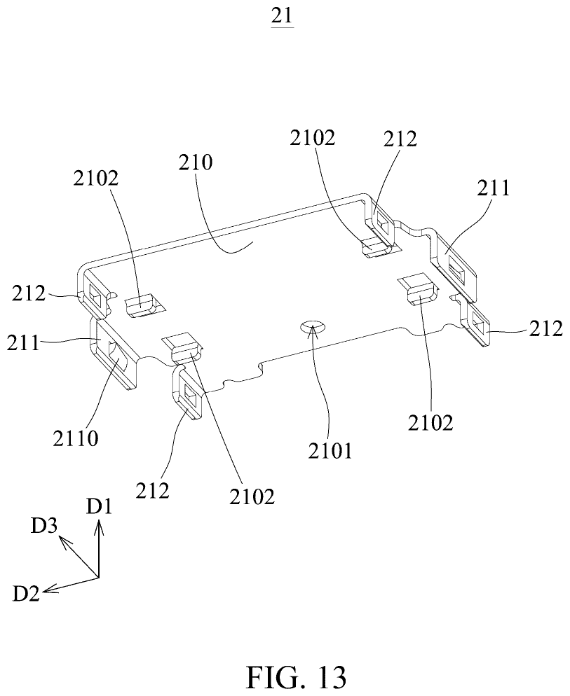

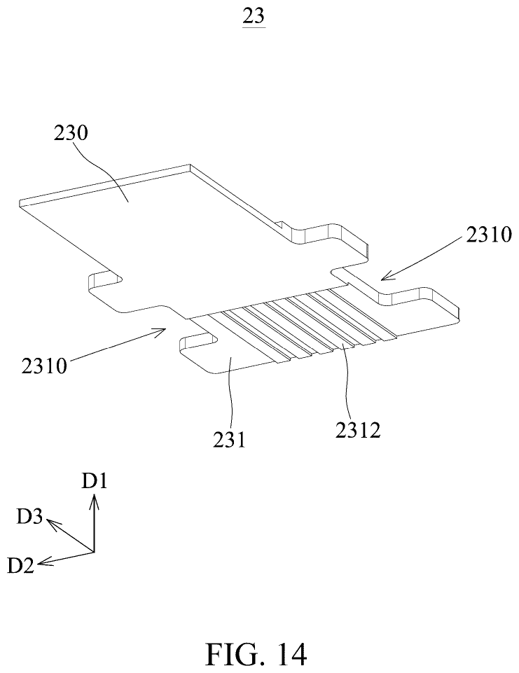

FIG. 13 is a perspective view of the upper housing 21, and FIG. 14 is a perspective view of the lower housing 22. The upper housing 21 and the lower housing 22 are formed by stamping and bending a metal plate. In this embodiment, the connector housing is a two-piece housing, but the present invention is not limited thereto. The connector housing may be a one-piece housing. In this embodiment, the connector housing is made of metal or alloy material, but the present invention is not limited thereto. The connector housing may be made of insulating synthetic resin or polymer material.

The details of the upper housing 21 are shown in FIGS. 11 and 13. The upper housing 21 includes a body portion 210. The body portion 210 has a flat surface which can be adsorbed by a vacuum nozzle. The body portion 210 of the upper housing 21 is formed with an alignment hole 2101. Similar to the alignment hole 1402, the alignment hole 2101 serves as an alignment mark which can be recognized by a machine vision system. Each lateral edge of the body portion 210 is formed with a latch portion 211. The latch portion 211 is arranged parallel to a plane perpendicular to the second direction D2 and is provided with a second engaging means which can be engaged with the first engaging means. In the state that the mating connector 20 is mated with the easy-lock connector 10, the locking arm 133 of the locking member 13 is positioned inside the latch portion 211 of the upper housing 21, allowing the first engaging means to be engaged with the second engaging means. In this embodiment, the second engaging means is embodied as a wedge-shaped protrusion 2110. Alternatively, the first engaging means may be embodied as a wedge-shaped protrusion, while the second engaging means may be embodied as a slot. Additionally, two engagement portions 212 are formed on each lateral edge of the body portion 210.

The details of the lower housing 22 are shown in FIG. 11. The lower housing 22 includes a body portion 220. The body portion 220 has a notch 2201, through which a portion of the bottom surface of the flat connection object 23 is exposed. The front and rear edges of the body portion 220 are respectively formed with two first limiting portions 2202 and two second limiting portions 2203. Each lateral edge of the body portion 220 is formed with two protrusions 222. By engagement of the protrusions 222 with the engagement portions 212, the upper housing 21 and the lower housing 22 are attached to each other and thus form the connector housing. It should be understood that the upper housing 21 and the lower housing 22 are not necessarily provided with engagement structures such as engagement portions or protrusions. Alternatively, the upper housing 21 and the lower housing 22 may be attached to each other by using laser welding.

Additionally, the body portion 220 of the lower housing 22 is formed with two positioning holes 2204 corresponding to the positioning posts 1101. By means of the positioning posts 1101, the mating connector 20 is positioned in place and prevented from being moved within a plane perpendicular to the first direction D1 or from being rotated about an axis parallel to the first direction D1 in the mated state. As a result, reliable contact between the electrode portion of the flat connection object 23 and the contacts 15 is ensured. The body portion 220 of the lower housing 22 is formed with two bosses 2205 serving as gap adjusters. The bosses 2205 prevent the flat connection object 23 from wobbling up and down with respect to the upper housing 21 and the lower housing 22.

FIG. 14 is a perspective view of the flat connection object 23. As shown in FIG. 14, the flat connection object 23 includes a head portion 231 and an extension portion 230. Each lateral edge of the head portion 231 is formed with a notch 2310. In this embodiment, the flat connection object 23 is a flexible flat cable (FFC), and other end of the extension portion 230 may be formed with another head portion. A plurality of electrode portions 2312 are arranged in the second direction D2 on the bottom surface of the head portion 231.

Reference is made to FIG. 13 again. As shown in FIG. 13, a plurality of third limiting portions 2102 are formed on the body portion 210 of the upper housing 21. The third limiting portions 2102 are abut against the inner edges of the notches 2310 of the flat connection object 23, preventing movement of the flat connection object 23 in the third direction D3 with respect to the connector housing. The first limiting portions 2202 and the second limiting portions 2203 formed on the body portion 220 of the lower housing 22 are respectively abut against the front and rear edges of the head portion 231 of the flat connection object 23, preventing movement of the flat connection object 23 in the third direction D3 with respect to the connector housing. Additionally, the positioning posts 1101 are abuts against the inner edges of the notches 2310 of the flat connection object 23, preventing movement of the flat connection object 23 in the second direction D2 with respect to the connector housing.

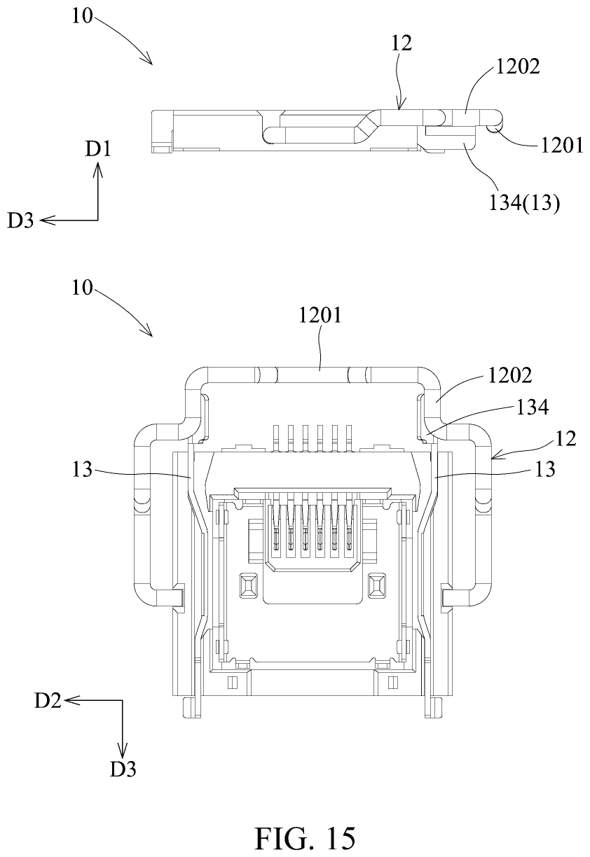

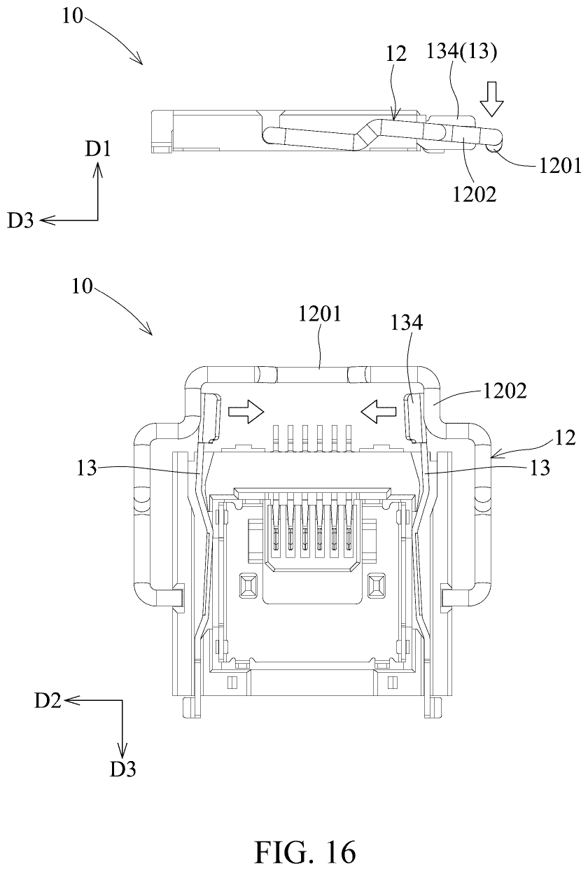

In the following description, the release of the lock on the mating connector 20 is described by referring to FIGS. 15 and 16. FIG. 15 is a view schematically illustrating the locking members of the easy-lock connector in the latched position, while FIG. 16 is a view schematically illustrating the locking members of the easy-lock connector according to the present invention in the unlatched position. For ease of illustration, the shell 14 of the easy-lock connector 10 is not shown in FIGS. 15 and 16.

In FIG. 15, the push bar 12 is located in an upper position corresponding to the latched position. At this time, the actuating portion 1202 of the push bar 12 is positioned above or resting on the actuated portion 134 of the locking member 13. In FIG. 16, the push bar 12 is located in a lower position corresponding to the unlatched position.

The inclined guide surface of the actuated portion 134 is oriented such that movement of the actuating portion 1202 of the push bar 12 from the upper position to the lower position in the first direction D1 causes the locking member 13 to be biased inward in the second direction D2 from the latched position to the unlatched position. Therefore, by pressing the operated portion 1201 of the push bar 12, the locking member 13 is biased from the latched position to the unlatched position, thereby releasing the lock on the mating connector 20.

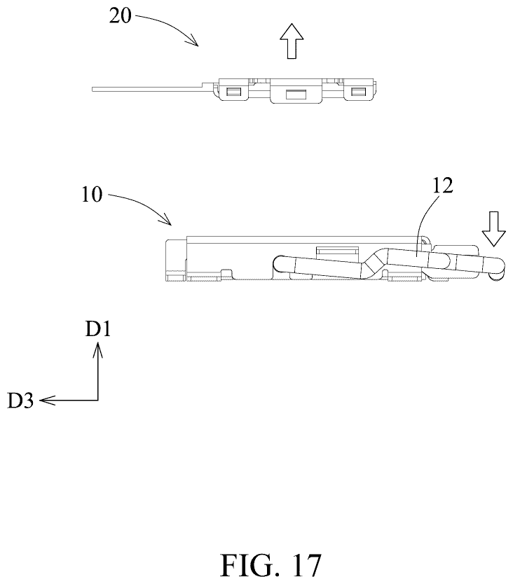

FIG. 17 is a view schematically illustrating the removal of the mating connector 20 from the easy-lock connector 10. When the push bar 12 is moved from the upper position to the lower position by pressing the operated portion 1201 of the push bar 12, the locking member 13 is biased from the latched position to the unlatched position, thereby releasing the lock on the mating connector 20. At this time, since the wedge-shaped protrusion serving as the second engaging means is disengaged from the slot 1330 serving as the first engaging means, the mating connector 20 can be removed from the easy-lock connector 10 in the first direction D1, as shown in FIG. 17.

The easy-lock connector according to the present invention indeed has the advantages of low profile and good operability. In addition, the easy-lock connector according to the present invention is particularly suitable for use in a compact or thin electronic machine. Additionally, the easy-lock connector according to the present invention is also suitable for automated assembly of a flat connection object and an easy-lock connector.

While this invention has been described in reference to a preferred embodiment, it should be understood that numerous changes and modifications could be made within the scope of the inventive concepts described. Accordingly, it is intended that the invention not be limited to the disclosed embodiment, but that it have the full scope permitted by the language of the following claims.

What is claimed is:

1. An easy-lock connector comprising:
an insulating housing, having an accommodation space, wherein a mating connector is to be inserted in a first direction into the accommodation space in such a manner that at least a part of the mating connector is received in the accommodation space;
a plurality of contacts held by the insulating housing, the plurality of contacts being arranged in a second direction perpendicular to the first direction, each contact including a contact portion extending into the accommodation space and a connection terminal portion opposite to the contact portion;
two lock members respectively arranged at two sides of the accommodation space in the second direction, each lock member including a fixed portion, a locking arm extending in a third direction perpendicular to the first direction and the second direction and an actuated portion formed on a free end of the locking arm, each lock member being arranged in such a manner that the locking arm is capable of moved between a latched position and an unlatched position and is normally biased to the latched position, the locking arm being formed with a first engaging means for being engaged with a second engaging means formed on the mating connector and preventing the mating connector from being detached from the easy-lock connector when the mating connector is inserted into the accommodation space; and
a push bar including a bar body and two rocker arms respectively formed on two ends of the push bar, the bar body including an operated portion extending in the second direction and two actuating portions respectively formed on two ends of the operated portion and extending in the third direction, the two rocker arms being capable of rotation about an axis parallel to the second direction with respect to the insulating housing,
wherein the two actuating portions of the push bar are brought to interact with the actuated portions of the two lock members by operating the operated portion so that movement of the two actuating portions in the first direction causes the locking arms of the two lock members to be moved away from the latched position in the second direction.

2. The easy-lock connector of claim 1, further including a shell attached to the insulating housing and covering at least a part of the insulating housing, wherein the shell is formed with two stopper tabs respectively positioned above the two rocker arms for preventing the two rocker arms from being swung upwardly.

3. The easy-lock connector of claim 1, wherein the first engaging means formed on the locking arm is in form of a slot.

4. The easy-lock connector of claim 1, wherein the actuated portion includes an inclined guide surface.

5. The easy-lock connector of claim 1, wherein the insulating housing includes a flat rectangular body and a peripheral wall formed along an edge of the flat rectangular body, the accommodation space is defined by the flat rectangular body and the peripheral wall, the peripheral wall is composed of a front wall portion, a rear wall portion opposite to the front wall portion and two lateral wall portions connecting the front wall portion and the rear wall portion, the two lock members are positioned adjacent to the two lateral wall portions respectively, and each lock member is arranged in such a manner that the fixed portion is positioned adjacent to the front wall portion and that the locking arm extends beyond the rear wall portion.

6. The easy-lock connector of claim 5, wherein the push bar is pivoted on the two lateral wall portions of the insulating housing.

7. The easy-lock connector of claim 5, wherein the peripheral wall has an upper inner edge which is chamfered.

8. The easy-lock connector of claim 1, wherein the insulating housing is formed with at least one positioning post for guiding insertion of the mating connector and positioning the mating connector.

9. A connector housing which is attached to an insertion end of a flat connection object, the flat connection object including a plurality of electrode portions formed on the insertion end, wherein a mating connector for the easy-lock connector of claim 1 is composed of the connector housing and the flat connector object, the connector housing comprises two latch portions which are arranged in parallel to a plane perpendicular to the second direction, and each latch portion is formed with the second engaging means for being engaged with the first engaging means.

10. A connector assembly including the easy-lock connector of claim 1 and the mating connector matable with the easy-lock connector, the mating connector comprising:
a flat connection object including an insertion end and a plurality of electrode portions formed on the insertion end; and
a connector housing attached to the insertion end of the flat connection object, the connector housing comprising two latch portions which are arranged in parallel to a plane perpendicular to the second direction, each latch portion being formed with the second engaging means for being engaged with the first engaging means.
